(19) United States
(12) Patent Application Publication
(10) Pub. No.: US 2026/0167143 A1
(43) Pub. Date: Jun. 18, 2026

(54) SEATBELT REMINDER

(71) Applicant: FCA US LLC, Auburn Hills, MI (US)

(72) Inventors: Sateesh Babu Palla, Chennai (IN); Matthieu Marcatel, Poissy (FR); Murali Balasubramanian, Chennai (IN)

(21) Appl. No.: 18/985,638

(22) Filed: Dec. 18, 2024

(51) Int. Cl. B60R 22/48

(52) U.S. Cl. CPC B60R 22/48; B60R 2022/4816; B60R 2022/4866

(57) ABSTRACT

A method for detecting seatbelt buckle status in a vehicle. The method may include determining a current buckle status of a seatbelt in the vehicle, determining a previous buckle status of the seatbelt at a particular point in time, and determining that the seatbelt is improperly buckled. The method may further include activating a seatbelt reminder alert to notify vehicle occupants that the seatbelt is improperly buckled.

### FIELD

The present disclosure relates to the field of vehicular safety systems and, more particularly, to providing reminders to vehicle occupants to engage seat belts.

### BACKGROUND

This section provides background information related to the present disclosure which is not necessarily prior art.

Most passenger vehicles include a notification system to notify the driver that one or more of the vehicle occupants have not buckled their seatbelt. The notification system typically includes visual and auditory alerts intended to both notify the occupants that a seatbelt is not buckled and encourage the occupant to buckle the seatbelt. However, some drivers and passengers may wish to avoid using a seatbelt and may be annoyed by the notification system. These drivers and passengers may resort to “gaming” behavior to trick the vehicle into believing they are properly restrained by the seatbelt when they are not. An example of “gaming” behavior may include buckling a tongue, disconnected from any belt, to a seatbelt latch. Another example may include buckling a tongue, connected to a belt, to a seatbelt latch in such a manner as the seatbelt remains behind the driver and does not restrain the driver. Such attempts to thwart the notification system may increase the likelihood of injury in the event of an accident.

### SUMMARY

This section provides a general summary of the disclosure, and is not a comprehensive disclosure of its full scope or all of its features.

According to a first aspect of the present disclosure, there is provided a method for detecting seatbelt buckle status in a vehicle, including determining, by at least one processor of the vehicle and following ignition of the vehicle, a current buckle status of a seatbelt in the vehicle, determining, by the at least one processor, a previous buckle status of the seatbelt at a particular point in time, determining, by the at least one processor and based on the previous buckle status of the seatbelt at the particular point in time, that the seatbelt is improperly buckled, and activating, by the at least one processor and based on the determination that the seatbelt is improperly buckled, a seatbelt reminder alert to notify vehicle occupants that the seatbelt is improperly buckled.

According to the first aspect, the seatbelt may be one or more seatbelts attached to a driver's seat or a passenger's seat.

According to the first aspect, determining the current buckle status further includes receiving, by the at least one processor, one or more signals from one or more latch sensors, the one or more signals indicating a state of the latch of the seatbelt.

According to the first aspect, determining the previous buckle status at the particular point in time includes accessing, by the at least one processor, a data log of at least one previous buckle statuses associated with a time stamp, and selecting, by the at least one processor, the most recent previous buckle status and its associated time stamp.

According to the first aspect, determining that the seatbelt is improperly buckled includes determining, by the at least one processor, that the current buckle status of the seatbelt is buckled, determining, by the at least one processor, that the previous buckle status of the seatbelt was buckled, determining, by the at least one processor, a time stamp of a most recent ignition of the vehicle, comparing, by the at least one processor, the time stamp of the previous buckle status to the time stamp of the most recent ignition of the vehicle, and determining, by the at least one processor, that the time stamp of the previous buckle status is further distant in time than the time stamp of the most recent ignition of the vehicle based on the comparison.

According to the first aspect, determining that the seatbelt is improperly buckled further includes determining, by the at least one processor, that the difference between the time stamp of the previous buckle status and the time stamp of the most recent ignition of the vehicle is greater than a predetermined threshold time.

According to the first aspect, the predetermined threshold time is a value between 5 minutes and 10 minutes.

According to the first aspect, the seatbelt reminder alert is an auditory alert or a visual alert.

According to the first aspect, the seatbelt reminder alert cannot be deactivated by the vehicle occupants until the seatbelt is unbuckled and then buckled again, at which time the seatbelt reminder alert is deactivated by the at least one processor.

According to a second aspect of the present disclosure, there is provided a method for detecting seatbelt buckle status in a vehicle, including determining, by at least one processor of the vehicle and following ignition of the vehicle, an occupancy status of a seat in the vehicle, determining, by the at least one processor of the vehicle, a current buckle status of a seatbelt coupled with a seat determined to be occupied, determining, by the at least one processor, a previous buckle status of the seatbelt at a particular point in time, determining, by the at least one processor and based on the previous buckle status of the seatbelt at the particular point in time, that the seatbelt is improperly buckled, and activating, by the at least one processor and based on the determination that the seatbelt is improperly buckled, a seatbelt reminder alert to notify vehicle occupants that the seatbelt is improperly buckled.

According to the second aspect, determining the current buckle status further includes receiving, by the at least one processor, one or more signals from one or more latch sensors, the one or more signals indicating a state of the latch of the seatbelt.

According to the second aspect, determining the previous buckle status at the particular point in time includes accessing, by the at least one processor, a data log of at least one previous buckle statuses associated with a time stamp, and selecting, by the at least one processor, the most recent previous buckle status and its associated time stamp.

According to the second aspect, determining that the seatbelt is improperly buckled includes determining, by the at least one processor, that the current buckle status of the seatbelt is buckled, determining, by the at least one processor, that the previous buckle status of the seatbelt was buckled, determining, by the at least one processor, a time stamp of a most recent ignition of the vehicle, comparing, by the at least one processor, the time stamp of the previous buckle status to the time stamp of the most recent ignition of the vehicle, and determining, by the at least one processor, that the time stamp of the previous buckle status is further distant in time than the time stamp of the most recent ignition of the vehicle based on the comparison.

According to the second aspect, determining that the seatbelt is improperly buckled further includes determining, by the at least one processor, that the current buckle status of the seatbelt is buckled, determining, by the at least one processor, that the previous buckle status of the seatbelt was buckled, determining, by the at least one processor, a time stamp of a most recent ignition of the vehicle, comparing, by the at least one processor, the time stamp of the previous buckle status to the time stamp of the most recent ignition of the vehicle, determining, by the at least one processor, that the time stamp of the previous buckle status is further distant in time than the time stamp of the most recent ignition of the vehicle based on the comparison, and determining, by the at least one processor, that the difference between the time stamp of the previous buckle status and the time stamp of the most recent ignition of the vehicle is greater than a predetermined threshold time.

According to the second aspect, the predetermined threshold time is a value between 5 minutes and 10 minutes.

According to the second aspect, the seatbelt reminder alert is an auditory alert or a visual alert.

According to the second aspect, the seatbelt reminder alert cannot be deactivated by the vehicle occupants until the seatbelt is unbuckled and then buckled again, upon which the seatbelt reminder alert is deactivated by the at least one processor.

According to the second aspect, determining an occupancy status of a seat in the vehicle further includes receiving, by the at least one processor, one or more signals from one or more pressure sensors.

According to the second aspect, determining an occupancy status of a seat in the vehicle further includes receiving, by the at least one processor, one or more signals from one or more radar sensors.

According to a third aspect of the present disclosure, there is provided a system for detecting seatbelt buckle status in a vehicle including at least one processor configured to determine, following ignition of the vehicle, an occupancy status of a seat in the vehicle, determine a current buckle status of a seatbelt coupled with a seat determined to be occupied, determine a previous buckle status of the seatbelt at a particular point in time, determine, based on the previous buckle status of the seatbelt at the particular point in time, that the seatbelt is improperly buckled, and activate, based on the determination that the seatbelt is improperly buckled, a seatbelt reminder alert to notify vehicle occupants that the seatbelt is improperly buckled.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically illustrates a vehicle having a passenger cabin according to a principle of the present disclosure;

FIG. 2 is a block diagram depicting the ECU and sensors according to a principle of the present disclosure;

FIG. 3 schematically illustrates a passenger seat of the vehicle according to a principle of the present disclosure; and

FIG. 4 is a flow chart depicting an example method for detecting improper seatbelt usage according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

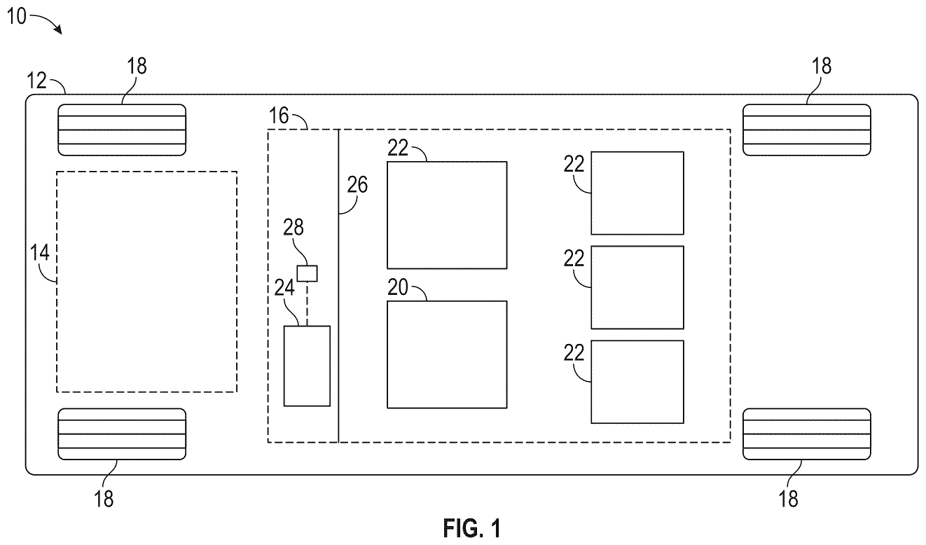

FIG. 1 schematically illustrates a vehicle 10 according to a principle of the present disclosure. Vehicle 10 includes a body 12 that defines an engine compartment 14 and a passenger cabin 16. Engine compartment 14 may house a propulsion system (not shown) that provides power to at least one wheel 18 of vehicle 10. Example propulsion systems (not shown) may include internal combustion engines, electrically-powered drive systems, and hybrid drive systems.

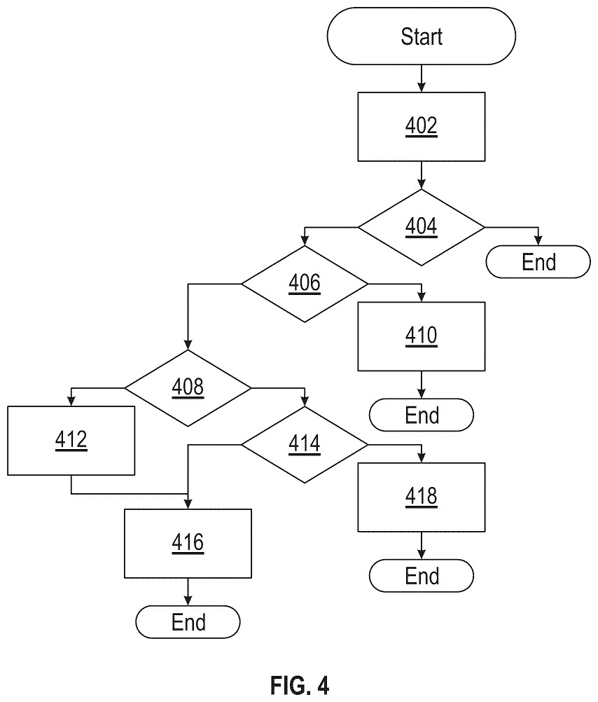

The passenger cabin 16 may house a driver's seat 20 and at least one passenger seat 22. While the passenger seat 22 is shown as a single seat (e.g., bucket seat), it should be understood that the passenger seat 22 may be a portion of a bench seat. The passenger cabin 16 may also include a display 24 on a dashboard 26 of the vehicle 10 that is in communication with an electronic control unit (ECU) 28 of the vehicle 10. The display 24 may be a heads-up display (HUD), an infotainment system, an instrument panel, or other means of displaying information to vehicle occupants. The display 24 may further include a seatbelt reminder alert (not shown), discussed with FIG. 4 below.

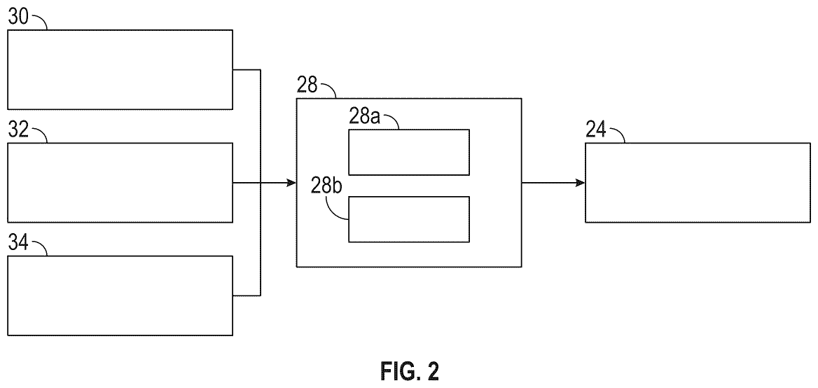

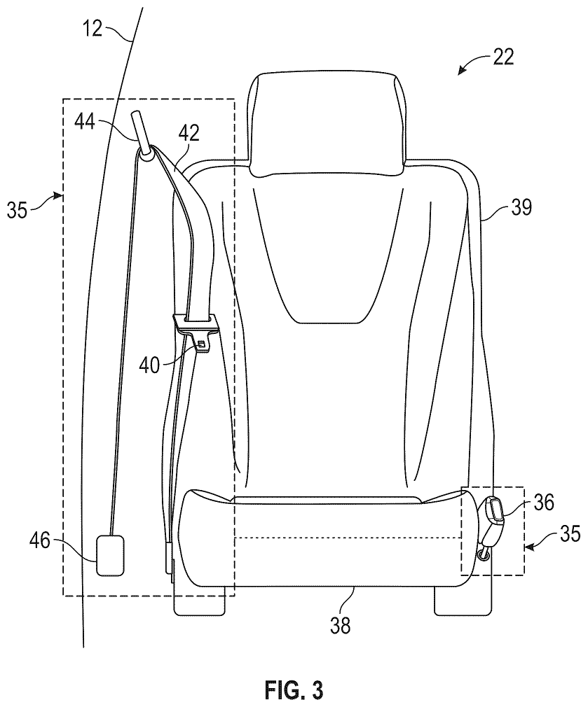

Referring to FIG. 2, the ECU 28 may comprise one or more processors 28a and one or more memory 28b. The ECU 28 may further be in communication with a plurality of sensors, including a latch sensor 30, a pressure sensor 32, and a radar sensor 34. The latch sensor 30 may be coupled with a seatbelt 35, further including a seatbelt latch 36 (shown in FIG. 3). The pressure sensor 32 may be coupled with the driver's seat 20 or passenger seat 22. The radar sensor 34 may be located within the passenger cabin 16. The ECU 28 may further be in communication with the display 24. Each sensor 30, 32, 34 and the display 24 may send signals to the ECU 28. The latch sensor 30 signals may be indicative of a latch status or buckle status of the seatbelt latch 36 (e.g., whether the seatbelt latch 36 is buckled or unbuckled). The pressure sensor 32 and radar sensor 34 signals may be indicative of an occupancy of a driver's seat 20 or passenger seat 22. While the description refers to single sensors, it should be understood that each sensor 30, 32, 34 may include a plurality of sensors. For example, the passenger cabin 16 may include a driver's seat 20 and four passenger seats 22, as shown in FIG. 1. In this example, the driver's seat 20 and each passenger seat 22 may include a seatbelt latch 36 and each seatbelt latch 36 may include a latch sensor 30 configured to send signals to the ECU 28 regarding its latch status. In this example, the driver's seat 20 and each passenger seat 22 may further include a pressure sensor 32 configured to send signals to the ECU 28 regarding an occupancy of the driver's seat 20 or passenger seat 22, as applicable.

Referring to FIG. 3, an example passenger seat 22 in accordance with the present disclosure is shown. While a passenger seat 22 is illustrated, it should be understood that driver's seat 20 is substantially similar to passenger seat 22 and functions in the same manner.

The passenger seat 22 includes a seatbelt 35, a seat pan 38, and a seat back 39. The seatbelt 35 may further include the seatbelt latch 36, a tongue 40, a belt 42, an anchor 44, and a retractor 46. The seat pan 38 may be configured to support the weight of a vehicle occupant while the seat back 39 may be configured to provide back support to the vehicle occupant. The tongue 40 may be coupled with and slidably supported by the belt 42. The belt 42 may be further coupled with the anchor 44 and the retractor 46, as is known in the art.

The seatbelt latch 36 may be configured to receive the tongue 40. The seatbelt latch 36 may include a latch sensor 30 in communication with the ECU 28. For example, the latch sensor may be a reed sensor which is activated and sends a signal to the ECU 28 when the tongue 40 enters the seatbelt latch 36. When the tongue 40 is immovably secured within the seatbelt latch 36, the seatbelt 35 is buckled, and the latch sensor 30 may signal this status to the ECU 28.

The seat pan 38 may further include a pressure sensor 32 in communication with the ECU 28. The pressure sensor 32 may detect a pressure or pressure distribution of a vehicle occupant as applied to the seat pan 38 by the weight and shape of the vehicle occupant. The pressure sensor 32 may send a signal to the ECU 28 indicative of said pressure or pressure distribution. Based on said signals, the ECU 28 may determine whether the passenger seat 22 is occupied by a vehicle occupant that should be restrained by the seatbelt 35. In making this determination, the ECU 28 may apply a minimum weight threshold in accordance with a 5th percentile adult female having a weight of 49 kg, as defined under R16 UNECE of Harmonized Technical United Nations Regulations for Wheeled Vehicles. For example, if the ECU 28 determines that the passenger seat 22 is occupied by a vehicle occupant weighing 49 kg or more, the ECU 28 may conclude that the passenger seat 22 is occupied by an adult who should be restrained by the seatbelt 35.

In another example, the ECU 28 may determine whether the passenger seat 22 is occupied by a vehicle occupant that should be restrained by the seatbelt 35 based on signals received from the radar sensor 34 in the passenger cabin 16. The radar sensor 34 may detect one or more objects occupying the passenger seat 22, as is known in the art. The ECU 28 may determine, based on signals received from the radar sensor 34, whether passenger seat 22 is occupied by a human occupant that should be restrained by the seatbelt 35, is occupied by non-human objects (e.g. a potted plant, a caged parrot, etc.), or is unoccupied. In making this determination, the ECU 28 may apply a minimum height threshold in accordance with a 5th percentile adult female having a height of 150.1 cm, as defined under R16 UNECE of Harmonized Technical United Nations Regulations for Wheeled Vehicles. For example, if the ECU 28 determines that the passenger seat 22 is occupied by a vehicle occupant having a height of 150.1 cm or more, the ECU 28 may conclude that the passenger seat 22 is occupied by an adult who should be restrained by the seatbelt 35.

In determining whether the passenger seat 22 is occupied by a vehicle occupant that should be restrained by the seatbelt 35, the ECU 28 may make the determination based on signals from the pressure sensor 32 or the radar sensor 34, or a combination of both.

While FIG. 3 depicts an example passenger seat 22, it should be understood that the above description of FIG. 3 may also apply to the driver's seat 20. While the example passenger seat 22 includes a certain number and arrangement of tongues 40, belts 42, anchors 44, and retractors 46 (typically described as a 3-point seatbelt system), other arrangements may be contemplated.

Referring to FIG. 4, a flow chart of an example method of the present disclosure is shown.

At step 402, the ECU 28 detects that the vehicle has been turned on. At this step, the ECU 28 may determine whether the driver's seat 20, one or more passenger seats 22, or a combination of both are occupied by a vehicle occupant that should be restrained by the seatbelt 35. As discussed above, the ECU 28 may make this determination based on signals from the pressure sensor 32 or the radar sensor 34, or a combination of both. In this example method, the ECU 28 has made the determination that only the driver's seat is occupied.

At step 404, the ECU 28 may determine the buckle status of the driver's seatbelt 35. The ECU 28 may receive a signal from the latch sensor 30 on the driver's seatbelt 35 indicating the buckle status. If the ECU 28 determines that the buckle status of the driver's seatbelt 35 is BUCKLED, then the ECU 28 may proceed to step 406. If the ECU 28 determines that the buckle status of the driver's seatbelt 35 is UNBUCKLED, then the ECU 28 may perform a conventional seatbelt reminder alert to compel the driver to buckle the driver's seatbelt 35, as is known in the art, and end the method at this step.

At step 406, having detected that the driver's seatbelt 35 is BUCKLED, the ECU 28 may determine when the driver's seatbelt 35 was last unbuckled. The ECU 28 may access data stored in memory 28b regarding the driver's seatbelt 35 including a previous buckle status and a timestamp for the last time the driver's seatbelt 35 was buckled or unbuckled. The ECU 28 may further access data stored in memory 28b regarding previous journeys including a time stamp of the previous time the vehicle 10 was turned off. If the ECU 28 determines that the previous buckle status of the driver's seatbelt 35 was BUCKLED, then the ECU 28 may proceed to step 408. If the ECU 28 determines that the previous buckle status of the driver's seatbelt 35 was UNBUCKLED, then the ECU 28 may proceed to step 410.

At step 408, having determined that the previous buckle status of the driver's seatbelt 35 was BUCKLED, the ECU 28 may evaluate the time stamp for the previous buckle status against the time stamp for the previous time the vehicle 10 was turned off. If the ECU 28 determines that the time stamp for the previous buckle status is further distant in time than the time stamp for the previous time the vehicle 10 was turned off, the ECU 28 may proceed to step 412. If the ECU 28 determines that the time stamp for the previous buckle status is less distant in time than the time stamp for the previous time the vehicle 10 was turned off, the ECU 28 may proceed to step 414.

At step 410, having determined that the previous buckle status of the driver's seatbelt 35 was UNBUCKLED, the ECU 28 may conclude that the driver is properly restrained and may end the method at this step.

At step 412, having determined that the time stamp for the previous buckle status is further distant in time than the time stamp for the previous time the vehicle 10 was turned off, the ECU 28 may conclude that the driver is not properly restrained and activate the seatbelt reminder alert to alert the driver. The seatbelt reminder alert may be an auditory alert, a visual alert, or both. The ECU 28 may cause the display 24 to display a visual alert to vehicle occupants. The ECU 28 may proceed to step 416.

At step 414, having determined that the time stamp for the previous buckle status is less distant in time than the time stamp for the previous time the vehicle 10 was turned off, the ECU 28 may evaluate the time stamp for the previous buckle status against an ignition time of the vehicle 10. If the difference between the time stamp for the previous buckle status and the ignition time of the vehicle 10 is greater than a threshold time, then the ECU 28 may conclude that the driver is not properly restrained and activate the seatbelt reminder alert to alert the driver. The ECU 28 may proceed to step 416. However, if the difference between the time stamp for the previous buckle status and the ignition time of the vehicle 10 is less than a threshold time, the ECU 28 may proceed to step 418.

A threshold time may be a predetermined or customer-defined grace period prior to ignition of the vehicle 10 wherein the driver may buckle the driver's seatbelt 35 without the ECU 28 determining such buckling to be improper (i.e., that the driver is not properly restrained). For example, the driver may enter the vehicle 10, buckle the driver's seatbelt 35, and delay starting the vehicle 10 due to a phone call, a radio “driveway moment,” or any number of similar reasons. In such event, it would be preferable for the ECU 28 to conclude that the driver's seatbelt 35 is properly buckled, so long as the delay between buckling the driver's seatbelt 35 and ignition of the vehicle 10 is reasonable. An example threshold time may be as short as 5 minutes or as long as 10 minutes. Further, while the example discusses the threshold time for a driver to buckle a driver's seatbelt 35, it should be understood that the threshold time for the driver to buckle the driver's seatbelt 35 may be different from the threshold time for a passenger to buckle a passenger's seatbelt 35. Additionally, the customer-defined grace period may be determined by a customer at the time of implementation.

At step 416, having activated the seatbelt reminder alert, the ECU 28 may monitor the buckle status of the driver's seatbelt 35. The ECU 28 may deactivate the seatbelt reminder alert once the driver has complied and unbuckled and buckled the driver's seatbelt 35. Once the ECU 28 has deactivated the seatbelt reminder alert, the ECU 28 may end the method at this step.

At step 418, having determined that the difference between the time stamp for the previous buckle status and the current time is less than a threshold time, the ECU 28 may conclude that driver's seatbelt 35 has been buckled recently and the driver is properly restrained. The ECU 28 may end the method at this step.

While the method of FIG. 3 is directed to monitoring the driver's seatbelt 35, it should be understood that the ECU 28 may monitor any seatbelt 35 in the vehicle 10. In one example, the ECU 28 may determine at step 402 that one or more passenger seats 22 are occupied. The ECU 28 may then determine at step 404 the buckle status of one or more passenger seatbelts 35 and perform the subsequent steps based on the buckle status of each of the passenger seatbelts 35. In another example, the ECU 28 may determine at step 402 that the driver's seat 20 and one or more passenger seats 22 are occupied. The ECU 28 may then determine at step 404 the buckle status of the driver's seatbelt 35 and the passenger seatbelts 35 and perform the subsequent steps based on the buckle status of the driver's seatbelt 35 and each of the passenger seatbelts 35.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for detecting seatbelt buckle status in a vehicle, comprising:
determining, by at least one processor of the vehicle and following ignition of the vehicle, a current buckle status of a seatbelt in the vehicle;
determining, by the at least one processor, a previous buckle status of the seatbelt at a particular point in time;
determining, by the at least one processor and based on the previous buckle status of the seatbelt at the particular point in time, that the seatbelt is improperly buckled; and
activating, by the at least one processor and based on the determination that the seatbelt is improperly buckled, a seatbelt reminder alert to notify vehicle occupants that the seatbelt is improperly buckled.

2. The method of claim 1, wherein the seatbelt may be one or more seatbelts attached to a driver's seat or a passenger's seat.

3. The method of claim 1, wherein determining the current buckle status further comprises receiving, by the at least one processor, one or more signals from one or more latch sensors, the one or more signals indicating a state of a latch of the seatbelt.

4. The method of claim 1, wherein determining the previous buckle status at the particular point in time comprises:
accessing, by the at least one processor, a data log of at least one previous buckle statuses associated with a time stamp; and
selecting, by the at least one processor, the most recent previous buckle status and its associated time stamp.

5. The method of claim 4, wherein determining that the seatbelt is improperly buckled comprises:
determining, by the at least one processor, that the current buckle status of the seatbelt is buckled;
determining, by the at least one processor, that the previous buckle status of the seatbelt was buckled;
determining, by the at least one processor, a time stamp of a most recent ignition of the vehicle;
comparing, by the at least one processor, the time stamp of the previous buckle status to the time stamp of the most recent ignition of the vehicle; and
determining, by the at least one processor, that the time stamp of the previous buckle status is further distant in time than the time stamp of the most recent ignition of the vehicle based on the comparison.

6. The method of claim 4, wherein determining that the seatbelt is improperly buckled further comprises:
determining, by the at least one processor, that the difference between the time stamp of the previous buckle status and the time stamp of the most recent ignition of the vehicle is greater than a predetermined threshold time.

7. The method of claim 6, wherein the predetermined threshold time is between 5 minutes and 10 minutes.

8. The method of claim 1, wherein the seatbelt reminder alert is an auditory alert or a visual alert.

9. The method of claim 8, wherein the seatbelt reminder alert cannot be deactivated by the vehicle occupants until the seatbelt is unbuckled and then buckled again, at which time the seatbelt reminder alert is deactivated by the at least one processor.

10. A method for detecting seatbelt buckle status in a vehicle, comprising:
determining, by at least one processor of the vehicle and following ignition of the vehicle, an occupancy status of a seat in the vehicle;
determining, by the at least one processor of the vehicle, a current buckle status of a seatbelt coupled with a seat determined to be occupied;
determining, by the at least one processor, a previous buckle status of the seatbelt at a particular point in time;
determining, by the at least one processor and based on the previous buckle status of the seatbelt at the particular point in time, that the seatbelt is improperly buckled; and
activating, by the at least one processor and based on the determination that the seatbelt is improperly buckled, a seatbelt reminder alert to notify vehicle occupants that the seatbelt is improperly buckled.

11. The method of claim 10, wherein determining the current buckle status further comprises receiving, by the at least one processor, one or more signals from one or more latch sensors, the one or more signals indicating a state of a latch of the seatbelt.

12. The method of claim 10, wherein determining the previous buckle status at the particular point in time comprises:
accessing, by the at least one processor, a data log of at least one previous buckle statuses associated with a time stamp; and
selecting, by the at least one processor, the most recent previous buckle status and its associated time stamp.

13. The method of claim 12, wherein determining that the seatbelt is improperly buckled comprises:
determining, by the at least one processor, that the current buckle status of the seatbelt is buckled;
determining, by the at least one processor, that the previous buckle status of the seatbelt was buckled;
determining, by the at least one processor, a time stamp of a most recent ignition of the vehicle;
comparing, by the at least one processor, the time stamp of the previous buckle status to the time stamp of the most recent ignition of the vehicle; and
determining, by the at least one processor, that the time stamp of the previous buckle status is further distant in time than the time stamp of the most recent ignition of the vehicle based on the comparison.

14. The method of claim 12, wherein determining that the seatbelt is improperly buckled comprises:
determining, by the at least one processor, that the current buckle status of the seatbelt is buckled;
determining, by the at least one processor, that the previous buckle status of the seatbelt was buckled;
determining, by the at least one processor, a time stamp of a most recent ignition of the vehicle;
comparing, by the at least one processor, the time stamp of the previous buckle status to the time stamp of the most recent ignition of the vehicle;
determining, by the at least one processor, that the time stamp of the previous buckle status is further distant in time than the time stamp of the most recent ignition of the vehicle based on the comparison; and
determining, by the at least one processor, that the difference between the time stamp of the previous buckle status and the time stamp of the most recent ignition of the vehicle is greater than a predetermined threshold time.

15. The method of claim 14, wherein the predetermined threshold time is between 5 minutes and 10 minutes.

16. The method of claim 10, wherein the seatbelt reminder alert is an auditory alert or a visual alert.

17. The method of claim 16, wherein the seatbelt reminder alert cannot be deactivated by the vehicle occupants until the seatbelt is unbuckled and then buckled again, upon which the seatbelt reminder alert is deactivated by the at least one processor.

18. The method of claim 10, wherein determining an occupancy status of a seat in the vehicle further comprises receiving, by the at least one processor, one or more signals from one or more pressure sensors.

19. The method of claim 10, wherein determining an occupancy status of a seat in the vehicle further comprises receiving, by the at least one processor, one or more signals from one or more radar sensors.

20. A system for detecting seatbelt buckle status in a vehicle comprising:
at least one processor configured to:
determine, following ignition of the vehicle, an occupancy status of a seat in the vehicle;
determine a current buckle status of a seatbelt coupled with a seat determined to be occupied;
determine a previous buckle status of the seatbelt at a particular point in time;
determine, based on the previous buckle status of the seatbelt at the particular point in time, that the seatbelt is improperly buckled; and
activate, based on the determination that the seatbelt is improperly buckled, a seatbelt reminder alert to notify vehicle occupants that the seatbelt is improperly buckled.
